(19) United States
(12) Patent Application Publication
(10) Pub. No.: US 2003/0068171 A1
(43) Pub. Date: Apr. 10, 2003

(54) Image forming apparatus having selectively removable image processing and toner modules

(75) Inventors: Ituro Katoh, Nara-ken (JP); Shoichiro Yoshiura, Yamatokoriyama-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 10/294,799

(22) Filed: Nov. 15, 2002

Related U.S. Application Data
(63) Continuation of application No. 08/866,300, filed on May 30, 1997, now abandoned.
Application No. 08/866,300 is a division of application No. 08/460,087, filed on Jun. 2, 1995, now Pat. No. 5,697,008.
Application No. 08/460,087 is a division of application No. 08/181,951, filed on Jan. 18, 1994, now Pat. No. 5,541,715.
Application No. 08/181,951 is a continuation of application No. 07/388,292, filed on Jul. 21, 1989, now abandoned.
Application No. 07/388,292 is a continuation of application No. 07/235,762, filed on Aug. 23, 1988, now abandoned.
Application No. 07/235,762 is a continuation of application No. 07/058,857, filed on Jun. 5, 1987, now abandoned.

(30) Foreign Application Priority Data
Jun. 6, 1986 (JP) P 61-132091

(51) Int. Cl. G03G 15/00

(52) U.S. Cl. 399/110

(57) ABSTRACT

An image formation apparatus having an image carrier; first unit comprising at least a cleaning system held on one supporter; and a second unit comprising a developing system to develop electrostatic latent images formed on the image carrier; the said first and second unit which can be mounted to or demounted from the image formation apparatus, a feeding unit to carry the toner used to remove toner from the said image carrier being provided on the said first unit, and a recovery container to recover the used toner carried by the said feeder provided on the said second unit.

### BACKGROUND OF THE INVENTION

This invention relates to an image formation apparatus having a unit to develop electrostatic latent images formed on an image carrier and a mechanism to recover waste toner.

In image formation equipment such as electronic photocopying equipment, an electrostatic latent image is formed on a photosensitive agent which is the image carrier and this latent image is developed by a developer. The toner used for this developing method has been generally black. Recently, however, mono-color developing using where red, blue and other toners are uses by changing the developing unit for installation to the main body of the equipment has been increasing. However, a compact image forming unit which including a developing system has not been developed.

### SUMMARY OF THE INVENTION

The object of this invention is to decrease the size of the unit which includes the developing equipment irrespective of the life of the image carrier by configuring the image formation unit with a first unit containing an image carrier and a second unit consisting of a developer and a waste toner recovery container.

Especially, this investigation is intended for the easy replacement of the developing unit and discarding of the waste toner by just replacing the second unit which includes the developer.

Briefly described, in accordance with the present invention, an image formation apparatus having a first unit consisting of an image carrier and at least a cleaner being held to one supporter and a second unit consisting of a developer to develop an electrostatic latent image formed on the image carrier, the said first and second unit being installed removably to the image formation apparatus, is provided.

### BRIEF DESCRIPTION OF THE DRAWINGS

The present will become more fully understood from the detailed description given hereinbelow and the accompanying drawings which are given by way of illustration only, and thus are not limitative of the present invention and wherein:

FIG. 1 is a schematic side sectional view of the electronic photocopying system according to this invention,

FIG. 2 is a general perspective view of the second unit,

FIG. 3 is a general perspective view of the first unit,

FIG. 4 is a perspective view of the copying machine with no second unit installed, and

FIG. 5 is a perspective view of the copying machine with the second unit installed.

### DESCRIPTION OF THE PREFERRED EMBODIMENT

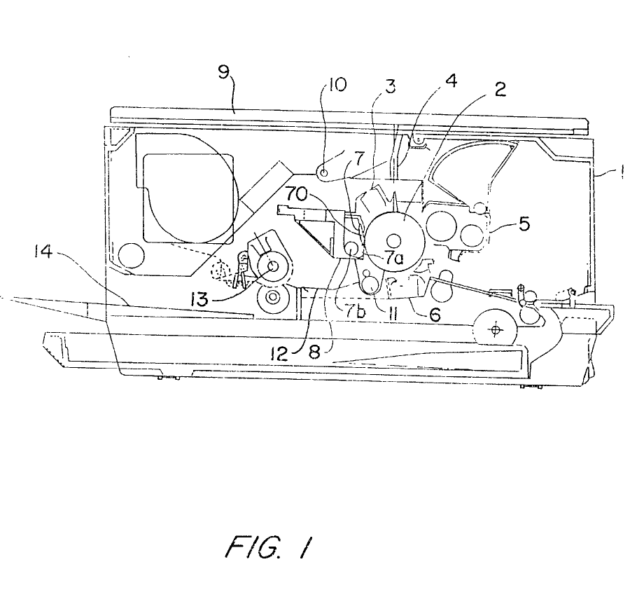

FIG. 1 is a schematic sectional view of an electronic photocopier according to this invention. At the approximate center of the copying machine 1, a drum-shaped photosensitive device 2 formed to generate a copied image is provided. The photosensitive device 2 is held with a drive mechanism, not shown, for rotation. Around the photosensitive device 2, a charger 3, light focuser/transmitter 4, developer 5, transferer 6, and cleaner 7 are arranged along the rotating direction to form the copying image. In this copying machine 1, at least the photosensitive device 2, charger 3 and cleaner 7 are held in one case to configure the first unit 8. This first unit 8 is held with a guide supporter, not shown, on the equipment main body side and can be taken out or reinstalled by any one by using the mounting handle on the unit.

An original stand 9 which is used to set the original and expose it with the exposure light source 10 is movably positioned on the copying machine 1. This original stand 9 is scanned in the lateral direction with a drive unit, not shown. The optical image obtained by the irradiation with the exposure light source 10 is projected on the optical conductive layer on the surface of the photosensitive device by the light focuser/transmitter 4. By this, an electrostatic latent image is formed on the photosensitive device 2 according to the image of the original and this latent image is visualized by the developer 5, which is the second unit.

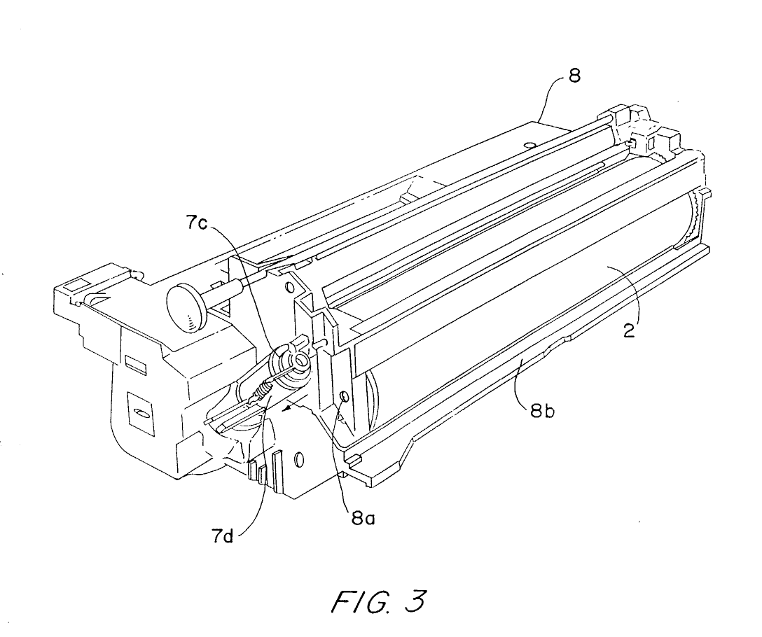

Then, the image visualized by the said developer 5 (image of the toner) is transferred onto the transfer paper which is carried from the paper feeder at the proper time by the transfer 6. At this time, about 20% of the toner remains on the surface of the drum of the photosensitive device 2. In order to remove this toner and use the drum for the next image forming process, a cleaner 7 is provided. This cleaner 7 pushes an elastic cleaning blade 70 to the surface of the photoelectric device 2 to scrape off the remaining toner on the rotating photosensitive device 2. The toner scraped off with the cleaning blade 70 is received by the waste toner receiver 7a positioned under the cleaning blade. At the position of this waste toner receiver 7a, a waste toner feeder 7b is provided for rotation. The waste toner feeder 7b carries the toner dropped to the waste toner receiver 7s in the direction of the rotating axis of the photosensitive device to the one side of the first unit. On the one side, a feeder 7c to carry the toner whose carrying direction as shown in FIG. 3 makes a right angle to the previous carrying direction is provided in connection with the above described waste toner carrier 7b. This carrier 7c faces the waste toner recovery container 56 which is provided in a single unit with the developer 5 described later. Especially, the outlet port provided in the carrier 7c and the opening of the waste toner recovery container 56 are positioned to face each other.

On the other hand, the transfer paper which was sent to the transfer position is separated from the surface of the drum of the photosensitive device 2 with the separator 11 after the transfer of the image and sent to the overheat fixer 13 along the feeding guide 12. In the fixer 13, the image of the toner powder on the transfer paper is fixed by heat and pressure and the transfer paper after fixing is discharged to the paper discharger 14.

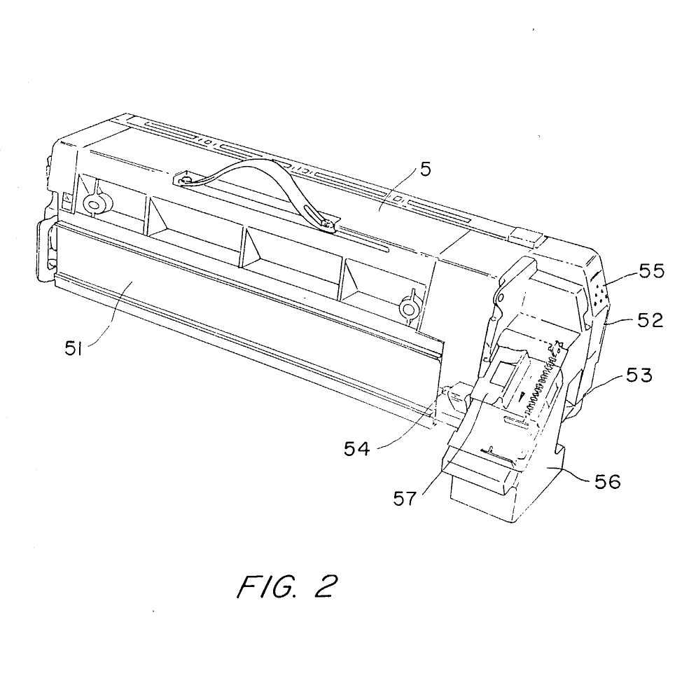

FIG. 2 is a general perspective view of the second unit consisting of the developer 5 and waste toner recovery container 56. When the second unit is mounted to the main body of the copying machine, the cover 51 over the developing opening is separated to expose the magnetic brush of the toner generated on the developing sleeve and to mount it to the mounting position of the main body of the copying machine holding the second unit mounting handle 52. Number 54 indicates a positioning boss to be locked to the positioning hole 8a provided on the side of the first unit 8 and number 52 is a locking claw to hold the developer 5 when it is installed to the main body of the copying machine. Number 55 indicates the color of the toner at the time of mono-color copying and can be seen from the indicating window 1b at the front cabinet 1a. Member 56 is a vessel for recovering waste toner which is carried from the first unit and held in one unit with the developing of stem 5. They are replaced at the same time. Number 57 is the cover for the waste toner receiving port which is opened in the direction of the arrow when the second unit is mounted. It prevents the waste toner from overflowing when the unit is taken out. It is designed so that, when the above-described cover 57 is opened, this opening becomes coincident with the discharge port of the feeder 7c of the first unit.

FIG. 3 is a general perspective view of the first unit 8 on the main body of the copying machine so as to be demounted from, or remounted to the main body of the copying machine. The first unit 8, in at least one case as described above, has a drum of photosensitive agent and a cleaner 7 to remove toner remaining on the surface of the photosensitive device. The waste toner removed from the surface of the photosensitive device 2 by the cleaner 7 is carried to the one side of the first unit By the feeder 7b, and then discharged from the discharge port by the feeder 87c. This feeder 7c is provided with cover 7d which moves in the direction of the arrow to open or close the discharge port. When the waste toner recovery container 56 provided in the second unit reaches a specified position, the cover 7d is opened opening the discharge port. The discharge port of the feeder 7c is provided so as to the coincident with the opening of the waste toner recovery container 56 of the second unit.

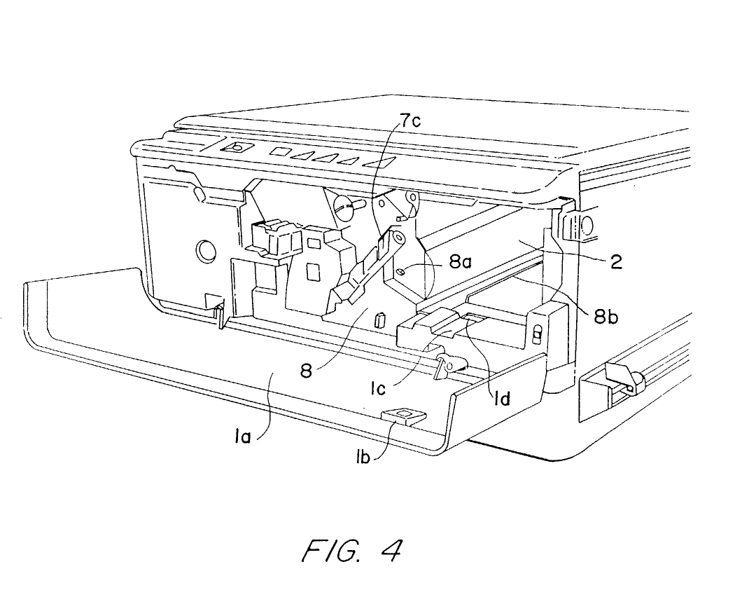

Here, the second unit cannot be installed unless the first unit 8 is installed to the main body of the copying machine. When the first unit 8 is installed to the main body of the equipment, a guide for the second unit is configured. For this purpose, the first unit 8 is provided with a guide 8b as shown in FIG. 3. This guide 8b provided on the first unit 8 not only guides the second unit, but also serves to position the developing magnetic brush precisely to the surface of the drum of the photoelectric together with the positioning boss 54 provided in the second unit. FIG. 4 shows the condition that the said first unit is mounted.

Mounting procedure for the second unit is shown below, The first unit 8 is mounted to the main body of the copying machine 1. The second unit is inserted to the main body of the copying machine with its bottom part advancing along the guide 1c formed by a part of the frame of the main body of the copying machine. Thus the second unit is led to the inner part by the guide 8b provided in the first unit 8 and connected to the image unit driver, not shown, in the inner part of the main body of the copying machine. At the same time, the positioning boss 54 of the second unit is fitted to the positioning hole 8a of the first unit 8 and locked. Since it is not restrained and may jump out, it is hitched to the catch 1d of the guide 1c of the frame of the main body of the copying machine with the locking claw 53 provided on the unit.

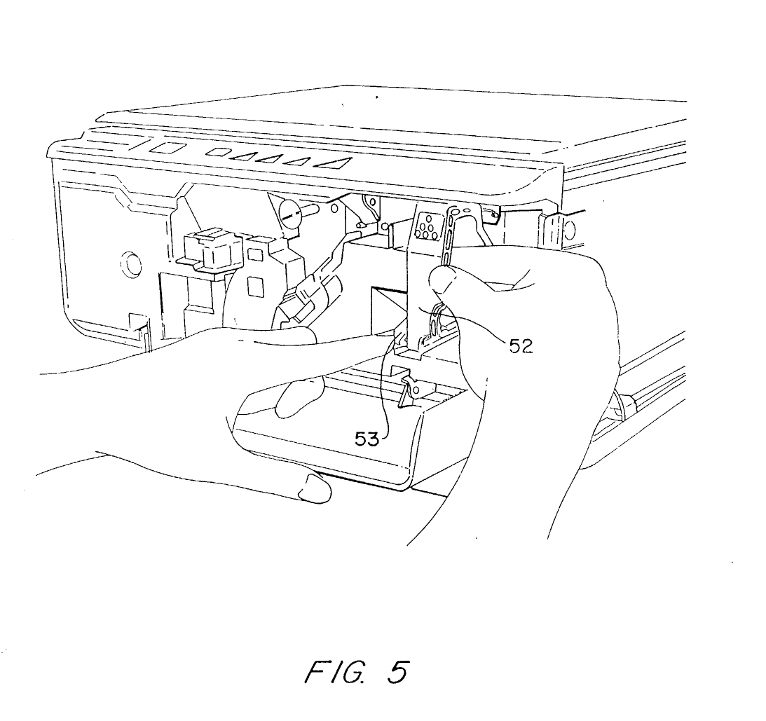

Upon the completion of the second unit, the covers 7d and 57 provided respectively at the discharge port of the feeder 7c to carry the waste toner on the first unit 8 and the opening of the waste toner recovery container 56 are opened so that the discharge port and receiving port align with each other and the recovery of waste toner to recovery container 56 becomes possible. FIG. 5 shows the condition where the second unit is installed.

By the above configuration, the second unit is positioned to the first unit 8, and, while the main body of the copying machine is working, the toner remaining on the photosensitive device 2 is carried through each feeder and recovered to the recovery container 56 held in the second unit. When the life of the second unit including the developer 5 has expired, for instance, when the toner of the developer 5 has been exhausted, only the second unit needs to be replaced. Therefore it is not necessary to increase the volume of the second unit including the developer 5 as a consequence of the life of the photosensitive device 2 in the first unit 8. Therefore, the second unit needs not correspond to the first unit and can be small.

The recovery container 56 has no relation with the first unit 8 either and therefore its size can be freely determined. It is advisable to determine the size of the waste toner recovery container 56 based on the capacity of the developer 5 to contain the toner. For instance, the capacity may be determined so that the toner of the developer 5 of the second unit is exhausted before the life of the photosensitive device 2 has expired and the waste recovery container becomes almost filled with waste toner when the second unit is replaced. In other words, the size of the recovery container 56 may be determined so that the recovery container 56 is almost filled with waste toner when the first unit is replaced. Therefore, the service life does not have to be considered when the second and first unit are replaced. Especially, the first unit can be designed freely and can be small.

As described above, in the system according to this invention, when the toner has been exhausted and the unit with a developer is replaced, the vessel to recover the waste toner which was recovered while the said unit was working is also replaced and therefore replacement is made in a short time and done easily. The image former is divided into two unit which have extremely different lives and as a result, each unit can be used effectively until its life has expired and can be small. While only certain embodiments of the present invention have been described, it will be apparent to those skilled in the art that various changes and modifications may be made therein without departing from the spirit and scope of the present invention as claimed.

What is claimed is:

1. An images formation apparatus having a first unit comprising at least a cleaning system held to one supporter and a second unit comprising a developing system to develop electrostatic latent images formed on an image carrier, the said first and second unit being able to be mounted to and demounted from the said image formation apparatus; a feeder to carry developing agent used to remove toner from said image carrier being provided on the said first unit side, and a recovery container to recover the used developing agent carried by the said feeder provided in the said second unit.

2. The image formation apparatus of claim 1, wherein said feeding means is rotated by rotation means so as to feed waste toner to said a side of said first unit.

3. The image formation apparatus of claim 1, wherein said feeding means feeds the waste toner to an opening of said recovery compartment means.

4. The image formation apparatus of claim 1, wherein said first and second unit means are removable from the body of said image formation apparatus.

5. The image formation apparatus of claim 1, wherein said first unit means is necessarily positioned within the body of said image formation apparatus before said second unit means is positioned within the body of said image formation apparatus.

6. The image formation apparatus of claim 5, wherein said first unit means comprises guid means through which said second unit means is positioned within the body of said image formation apparatus.

7. An image formation apparatus comprising:
Image formation means for forming image corresponding to an original; first unit means for visualizing the image using toner;
second unit means for recovering waste toner after used with said first unit means;
said first unit means being removable from the body of the image formation apparatus independently from both the volume of waste toner stored in said second unit means and the life time of an image visualizing member of said first unit means;
so that said first unit means become compact irrespective of the property of said second unit means.

8. The image formation apparatus of claim 7, wherein the volume of said second unit means is independent from the volume of recovery compartment means of said second unit means for receiving waste toner.

9. The image formation apparatus of claim 7, wherein the volume of said waste toner recovery compartment means corresponds to the full volume of waste toner which is waste from the toner provided from the said first unit means.
